(19) United States
(12) Patent Application Publication
(10) Pub. No.: US 2007/0274279 A1
(43) Pub. Date: Nov. 29, 2007

(54) Distributed antenna system employing digital forward deployment of wireless transmit/receive locations

(76) Inventors: Steven Andrew Wood, Bristol (GB); Matthew J. Hunton, Liberty Lake, WA (US); Christian Glen Luke, Bristol (GB); Simon Maurice Whittle, Bristol (GB); David Porte, Harvard, MA (US); Anthony Demarco, Newport Beach, CA (US)

Correspondence Address: David L. Henty;MYERS DAWES ANDRAS & SHERMAN LLP, Ste. 1150, 19900 MacArthur Blvd., Irvine, CA, 92612, US

(21) Appl. No.: 11/639,753

(22) Filed: Dec. 15, 2006

Related U.S. Application Data
(60) Provisional application No. 60/752,315, filed on Dec. 19, 2005.

(51) Int. Cl. H04J 1/00

(52) U.S. Cl. 370/343

(57) ABSTRACT

A communication system implements a method of bidirectional communication of signals to/from one or more wireless transmit locations. Transmitting signals to one or more wireless transmit locations includes obtaining a plurality of signals having different protocols, from a plurality of base stations, then converting the plurality of signals into common digital network protocol signals, and transmitting the common protocol signals over a transmission network to one or more wireless transmit locations. Receiving signals from one or more wireless transmit locations includes transmitting digital signals using a common protocol, from one or more wireless receive locations over the transmission network, converting the received digital signals into a plurality of signals having different protocols corresponding to a plurality of base stations implementing said different protocols, and providing the plurality of differing protocol signals to said corresponding plurality of base stations.

### RELATED APPLICATION

This application claims the benefit under 35 U.S.C. 119 (e) of U.S. provisional patent application Ser. No. 60/752,315, filed on Dec. 19, 2005, incorporated herein by reference in its entirety.

### FIELD OF THE INVENTION

This invention relates to the field of wireless communications systems and methods.

### BACKGROUND OF THE INVENTION

In recent years, wireless communications has grown to include not only voice but also data. Most wireless markets include several competing service providers. Both of these factors have increased the need for wireless transmission/reception (T/R) locations within a given geographic area. Traditional wireless T/R locations are generally placed outdoors. Such locations would include a base station with transmission tower, or a building deployed base station with T/R antennas attached to the building exterior. Such traditional deployments have three problems. First, as T/R locations have increased, public opposition to them has grown. With growing public opposition, zoning requirements have been changed to prohibit the number, appearance, and transmitted power level of T/R locations. Second, the expense of such traditional T/R deployments is high. A location of sufficient size must be purchased or leased. Leased property may also come with additional access and aesthetics requirements. Third, building construction methods often prevent communication with indoor wireless customers. This third problem requires adding indoor T/R locations further increasing the required number of T/R locations geographically deployed.

To meet the challenges presented above, distributed antenna networks have been developed and deployed. Distributed antenna networks provide T/R signal paths to locations remote from a traditional base station. These signal paths are generally created by coaxial cable, RF over fiber optic links, or by conversion of the RF signals (transmit and receive) to data and data transmission over fiber optic links. By these methods, one base station can create several different T/R locations. Unfortunately, such links all impact communication performance. Coaxial cables have loss affecting both transmitted signal power and receive noise figure. RF over fiber links operate at low power levels and have limited dynamic range. Data conversion methods require regeneration of analog signals, frequency synchronization with the host base station, and provide limited dynamic range. Because of these issues, distributed antenna networks often require inclusion of active repeaters at the remote T/R location. These repeater circuits include power amplifiers, low noise amplifiers, dynamic power control circuits, power supplies, and passive RF circuits such a filters, hybrid combiners, and circulators. Since the active circuits may fail, monitoring circuits must also be included. When included in a wireless network, repeater based T/R locations must include operation, administration, and maintenance (OA&M) communication. Any solution deploying repeater based T/R locations must therefore include an OA&M data network.

As mentioned above, most wireless markets include several competing service providers. Traditionally, wireless service providers would deploy their own network of T/R locations. In a given geographic area, the number of service providers multiplies the number of T/R locations. This has reached a point of impracticality forcing service providers to share resources. Neutral host companies have been created which lease shared resources to several competing wireless service providers. Competing wireless service providing companies make their own decisions about the base station equipment they purchase. Also, it is common that each service providing company will operate with a different air interface (CDMA, WCDMA, GSM, etc). These air interfaces use different frequency references and synchronization methods. These differences can introduce complexity into neutral host distributed T/R networks. Accordingly, a problem presently exists in efficiently and cost effectively providing the desired number of T/R locations in a wireless communications network.

### BRIEF SUMMARY OF THE INVENTION

In a first aspect the present invention provides a method of communicating signals to one or more wireless transmit locations. The method comprises receiving a plurality of signals having different protocols, from a plurality of base stations, converting the plurality of signals into common digital network protocol signals, and transmitting the common protocol signals over a transmission network to one or more wireless transmit locations.

In a preferred embodiment, receiving a plurality of signals comprises receiving a plurality of signals having different protocols with independent frequency references and synchronizations. Converting the plurality of signals comprises converting the plurality of signals from corresponding base station references into common network reference signals and synchronizations. Receiving a plurality of differing protocol signals comprises receiving digital protocol signals and analog protocol signals. Converting a communication signal from each base station reference into a common network reference signal further comprises digitally re-sampling the digital signal using the network reference. The analog protocol signals can include baseband signals and wherein converting the plurality of signals further comprises digitally sampling the baseband signals. The analog protocol signals can also include RF or IF signals.

The method can further include emulating the differing protocol signals in bidirectional communication with said plurality of base stations, and transmitting the common protocol signals from the transmit locations over one or more antennas. One or more transmit locations include radio heads, wherein the method further includes transmitting the common protocol signals from the radio heads over wireless channels. Transmitting the common protocol signals can further include transmitting the common protocol signals over a transmission network comprising an existing shared fiber network, to one or more wireless transmit locations.

The method can further include the steps of: transmitting digital signals using a common protocol, from one or more wireless receive locations over the transmission network; receiving the digital signals and converting the received digital signals into a plurality of signals having different protocols corresponding to a plurality of base stations implementing said different protocols; and providing the plurality of differing protocol signals to said corresponding plurality of base stations.

In another aspect the present invention provides a distributed antenna system for digital transmission of signals to one or more remotely located transmit locations, comprising a concentrator that is configured to receive a plurality of signals having different protocols, from a plurality of base stations, and which converts the plurality of signals into common digital network protocol signals; one or more wireless transmit locations each having one more antennas; and a communication module that is configured to transmit the common protocol signals over a transmission network to said one or more wireless transmit locations.

In a preferred embodiment, the plurality of signals have different protocols with independent frequency references and synchronizations. The concentrator includes a converter that is configured to convert the plurality of differing protocol signals from corresponding base station references into common network reference signals and synchronizations. The communication module is further configured to transmit the common protocol signals over a transmission network including an existing shared fiber network, to one or more of the remotely located transmit locations.

The converter is further configured to convert the plurality of signals into common network protocol digital streams, and the concentrator further includes a formatter that is configured to format the digital streams into data packets for routing throughout a transmission network; and the communication module is further configured to transmit the data packets over a packet transmission network to one or more of the remotely located transmit locations. Preferably, the formatter is further configured to format the digital streams into internet protocol (IP) data packets, and the communication module is further configured to transmit the data packets over a packet transmission network using the IP network transmission protocol. The formatter is further configured to include routing information in each packet to enable routing each packet through the packet transmission network to a selected transmit location.

The concentrator is further configured to receive digital signals using a common protocol, from one or more receive locations over the transmission network, and to convert the received digital signals into a plurality of signals having different protocols corresponding to the plurality of base stations implementing said different protocols. The common protocol digital signals comprise common network reference signals, wherein the converter is further configured to convert the received common network reference signals into a plurality of differing base station reference signals. Preferably, the communication module is further configured to receive data packets, such as internet protocol (IP) data packets, from the transmission network, the formatter is further configured to transform the data in the packets into common network protocol digital streams, and the converter is further configured to convert the received common network protocol digital streams into a plurality of differing base station reference signals.

Further aspects of the invention are provided in the following detailed description.

### BRIEF DESCRIPTION OF THE DRAWINGS

FIG. 1 shows a block diagram of a digitally distributed radio network comprising one base station concentrator and many remote site distributors (only one remote site distributor is shown) with each remote site distributor supporting one or more radio heads internal or external to the remote site distributor, in accordance with a preferred embodiment of the invention.

FIG. 2 shows a more detailed block diagram of the base station concentrator portion of a digitally distributed radio network, in accordance with a preferred embodiment of the invention.

FIG. 3 shows a more detailed block diagram of a remote site distributor portion of a digitally distributed radio network, in accordance with a preferred embodiment of the invention.

FIG. 4 shows a block diagram of one embodiment of a radio head in accordance with the present invention comprising a data packet formatter, a digital transceiver, and one or more antennas used for MIMO (Multiple Input Multiple Output) or diversity purposes.

FIG. 5 shows a block diagram of another embodiment of a radio head in accordance with the present invention comprising a data packet formatter which supports several digital transceivers, the digital transceiver outputs combined using RF conditioning circuits (filters networks, hybrid combiners, etc.) connected to one or more antennas used for MIMO or diversity purposes.

FIG. 6 shows a block diagram of another embodiment of a radio head in accordance with the present invention comprising a data packet formatter which supports several digital transceivers, said transceiver outputs each connected to one or more antennas used for MIMO or diversity purposes in separate sectors.

FIG. 7 shows a block diagram of another embodiment of a radio head in accordance with the present invention comprising a data packet formatter which supports several protocol converters with each protocol converter providing separate RF and OA&M (operation, administration and maintenance) paths, said RF paths combined through RF signal conditioning (filter networks, hybrid combiners, etc.), said OA&M paths concentrated in a data hub, said RF combined and OA&M concentrated paths connected to a single RF transceiver supporting one or more antennas used for MIMO or diversity purposes.

### DETAILED DESCRIPTION OF THE INVENTION

The present invention provides a digitally distributed T/R network, which addresses the above noted problems. In particular, the disclosed network is capable of operating with independent frequency reference and synchronization methods, capable of connecting to one or more base stations including equipment manufactured by various suppliers, as well as other features described below.

In a preferred implementation described in detail below, each base station will first connect to one or more signal protocol converters. As used herein ‘protocol’ means a base station communication standard (such as CPRI/OBSAI/RF, all well known in the art) supporting the separate air interface standard of the communication signal (such as CDMA/GSM/iDEN, also all well known in the art). Each base station signal interface can provide data or analog (RF, IF, or baseband) protocols along with OA&M information. The primary purpose of the protocol converter is to transition both T/R and OA&M information from the base station protocols to common network protocols. Accordingly, custom protocol converters will preferably be provided for each unique base station type (e.g. different base station manufacturers or different base station models form the same manufacturer). The secondary purpose of the protocol converter is to transition the T/R signal timing and frequency reference from the base station reference to the common network reference. For data interfaces, this is done by digitally re-sampling the common signal protocol transmit data using the network reference and re-sampling common signal protocol receive data using the base station reference. For analog signal protocols (RF, IF, or baseband) the analog-to-digital and digital-to-analog conversions are simply referenced to the network.

With a common protocol and reference created, each base station interface is then provided to a formatter and formatted for network distribution. This formatting includes converting continuous signal data streams, both to-and-from each protocol converter, and OA&M data, both to-and-from each protocol converter, into data packets for routing throughout the network. By distributing the base station data in packet form, transmit and receive signal information from one base station interface can produce signal transmission and reception at one or more remote locations. By providing this functionality the cost, performance, and aesthetics goals of a modern wireless network can be achieved.

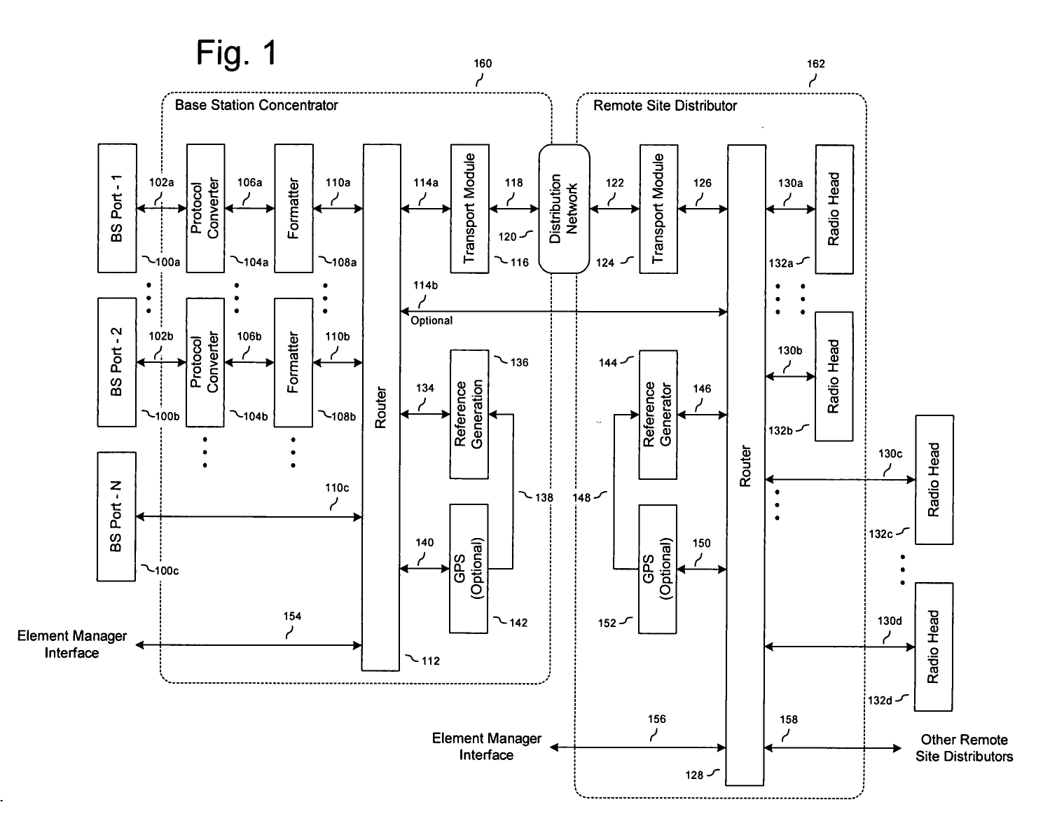

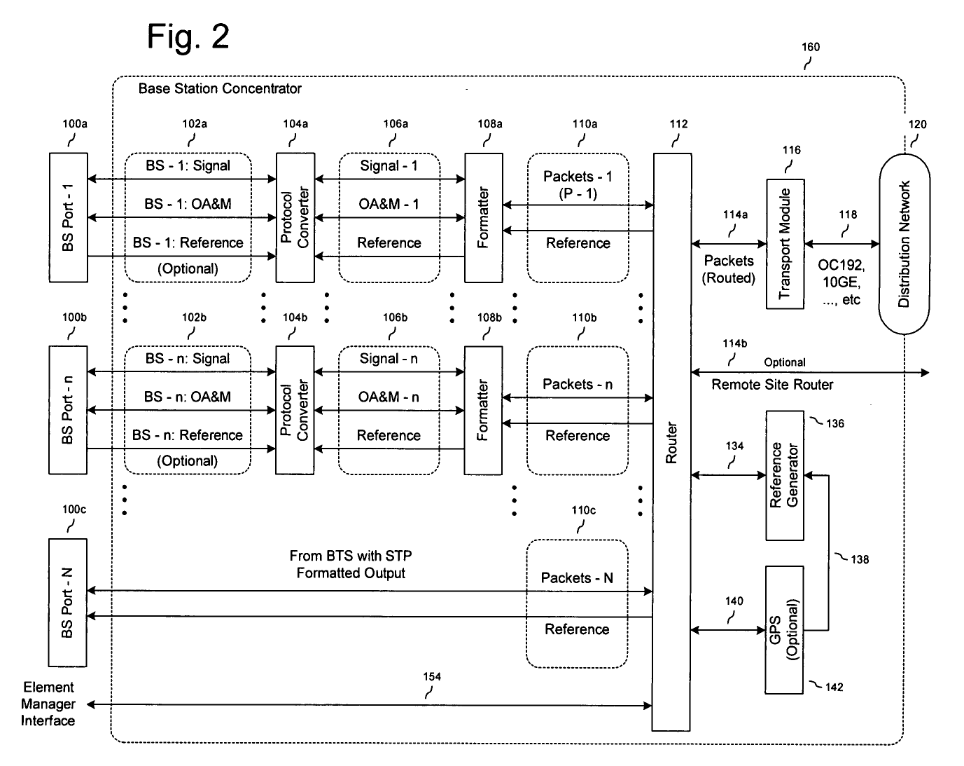

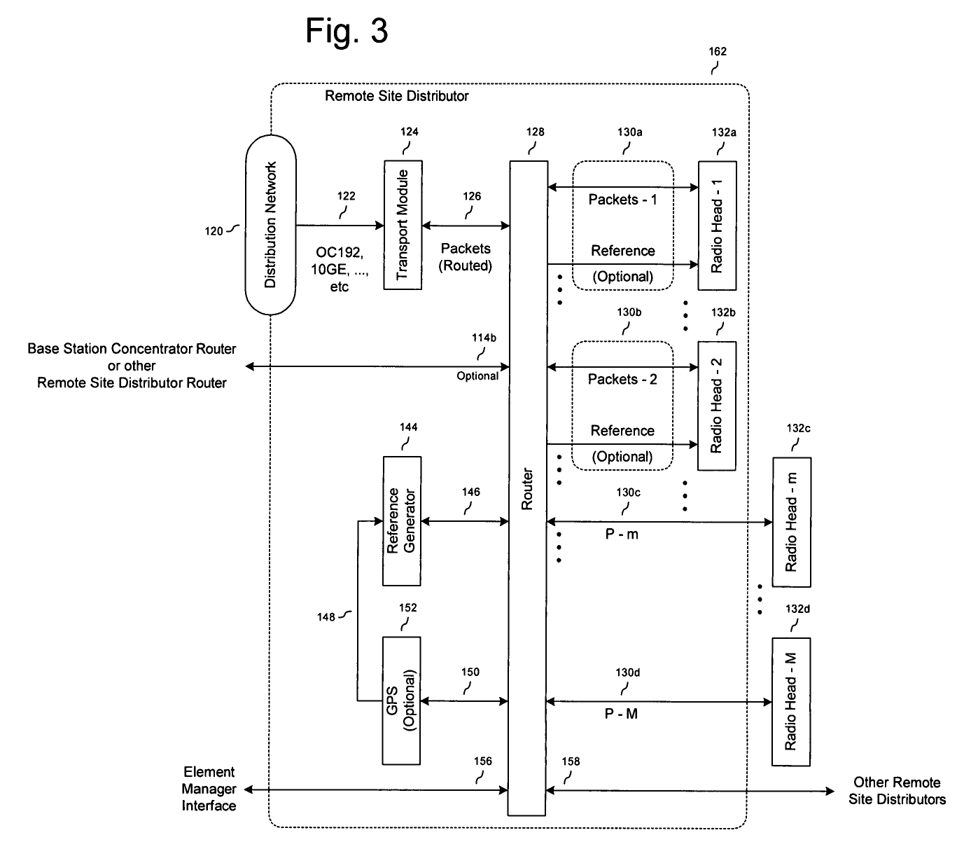

Next, referring to FIGS. 1-3 a preferred embodiment of the digitally distributed network of the present invention will be described. FIG. 1 shows a block diagram of a digitally distributed radio network comprised of one base station concentrator (160) and one of many remote site distributors (162) (only one remote site distributor (162) is shown). Each remote site distributor (162) supports one or more radio heads (132, a, b, c), internal or external to the remote site distributor (162). One remote site distributor (162) can also directly connect (158) to other remote site distributors. FIG. 2 provides a detailed block diagram of the base station concentrator (160). FIG. 3 shows a detailed block diagram of the remote site distributor (162). Item identification numbering is identical for all three drawings. FIG. 1 is provided as an overview of the present invention whereas FIG. 2 and FIG. 3 provide more descriptive detail.

The base station concentrator (160) connects to several base station ports (100a, b, c). Base station port 100c is shown for future applications where base station manufacturers provide ports specifically designed for the distribution network defined by the present invention. The future base station deployment port (100c) will be discussed later in this description. Current base station ports (100a, b) provide signal information, and OA&M information (operation, administration, and maintenance) and optionally the base station reference signal. These base station ports (100a, b) may come from one or more base stations co-located with the base station concentrator (160). When more than one base station is co-located, these base stations can be manufactured by one or more vendors and operated by one or more wireless service providers.

Base station port (100a, b) signal information communication is bi-directional including both transmit and receive information. More than one transmit and or receive signal can be provided for diversity or for Multiple Input Multiple Output (MIMO) communication enhancement purposes. Both transmit and receive signals may include several independent information channels. These channels may be isolated through code, frequency, or time division means. The signal information provided at each base station port will conform to a digital or analog protocol. Digital and analog protocols will be described separately.

When a base station port (100a, b) uses a digital protocol such as CPRI or OBSAI (which are industry standard digital protocols well known to those skilled in the art) or some other custom protocol for signal information, a protocol converter (104a, b) within the base station concentrator (160) will process the base station data to-and-from a common baseband channel protocol. Each common baseband channel will span a fixed bandwidth (e.g. 15 MHz). A common baseband channel may include one or more frequency division carriers in each transmit and receive direction. When first creating the common baseband channel for transmit information, the base station reference is used. This reference may be provided directly at the base station port or may be recovered from the signal data bus (see FIG. 2, item 102a, b). After creating the transmit information common baseband channel, the reference is transferred to the network reference through a digital re-sampling process within the protocol converter (104a, b). Reverse steps are used for the receive information with the common baseband channel operating on the network reference being digitally re-sampled onto the base station reference. The protocol converter (104a, b) therefore provides transmit and receive information to-and-from the distribution network operating with a common baseband channel protocol using a common network reference.

When a base station port (100a, b) uses an analog protocol (baseband, IF, or RF), a protocol converter (104a, b) within the base station concentrator (160) will analog-to-digital convert the transmit signal information, and digital-to-analog convert the receive information to-and-from the common baseband channel protocol. The network reference (see FIG. 2, item 106a, b) will be used to derive the sampling clock. Such a protocol converter (104a, b) will therefore once again provide transmit and receive information to-and-from the distribution network operating with a common baseband channel protocol using a common network reference.

As stated above, each base station port (100a, b) provides OA&M information. This information may be in an analog or digital format. OA&M information is also processed in the protocol converter (104a, b). Regardless of format, the protocol converter (104a, b) will convert OA&M information to-and-from the base station port (100a, b) into a common digital OA&M protocol used by the network. For example, if the base station port (100a, b) provides an analog voltage which represents the desired transmit gain, the protocol converter (104a, b) will produce a digital message commanding the combined network elements to produce the desired gain from the port (100a, b) input to the remote radio head (132a, b, c, d) output. Also, if the base station port (100, a, b) requires an analog voltage proportional to the transmitted signal power at the remote radio head (132a, b, c, d) output, the network will provide this information to the protocol converter (104a, b) from the radio head (132a, b, c, d). The protocol converter (104a,b) will then produce the necessary analog voltage for the base station port (100a, b). Obviously, if the base station port (100a, b) uses a digital protocol to communicate information to attached systems, the protocol converter (104a, b) need only to translate the bi-directional link information to the network common OA&M protocol. In instances where the network is not capable of producing the exact information need by the base station port (100a, b), the protocol converter (104a, b) will emulate communication thereby maintaining base station operation.

From the above few paragraphs it should be obvious that unique protocol converters (104a, b) will be necessary for each base station manufacturer or base station manufacturer base station model. Protocol converters (104a, b) will therefore be adapted to meet each unique base station port interface, as will be apparent to those skilled in the art. With the protocol converters in place, all base stations will appear to have identical interfaces.

Following the protocol converters (104a, b) are data formatters (108a, b). These data formatters convert transmit information from real time data streams to data packets. Data packets can then be sent to the router (112) for distribution throughout the network. This distribution could include sending the transmit data from one base station port (100a, b) to many radio heads (132a, b, c, d). Such transmission is referred to as simulcast. On the receive side, receive data packets addressed to a particular base station port are sent from the router (112) to the data formatter (108a, b) for conversion to real time data streams (see FIG. 2, 106a, b). Just as the transmit data can be sent to one or more radio heads (132a, b, c, d) for simulcast, receive data from various radio heads (132a, b, c, d) can be sent to one base station port. As mentioned earlier, base station ports often include more than one receive signal. For example, each radio head (132a, b, c, d) may include diversity receivers for link enhancement. In the case of diversity receive, two receive signals, diversity 1 and diversity 2, would be provided from each radio head (132a, b, c, d). The formatter (108) will produce a real time signal stream from each radio head (132a, b, c, d) receive path and then separately combine all diversity 1 signal streams and all diversity 2 signal streams. These combined diversity paths will then be provided to the protocol converter (104a, b). More detail on simulcast operation, in particular delay equalization, will be given in later paragraphs.

The use of packet data for signal distribution provides an advantage over prior art systems. Data packets are more convenient than continuous data streams because they permit the use of packet switched equipment, as opposed to circuit switched equipment. Each packet can be addressed to one or more remote elements and can be sent over modern internet protocol (IP) based networks.

As mentioned earlier, base station port 100c is shown for future base station deployments. Such base stations would be designed specifically to include base station ports (100c) for use with the present invention. When such base stations become available, the router (112) will provide the base station with the network reference (see FIG. 2, 110c). With the network reference provided, the base station can provide data packets directly to the router (112) that were created using the network reference. Future base stations providing such ports will reduce the cost and complexity of the base station concentrator (160).

The router (112) distributes signal packets, OA&M packets, and network reference information. Reference information may be distributed via a common clock or recovered from the signal data bus (see FIG. 2, 110a, b, c). The router (112) receives the reference signal from a reference generator (136). The reference generator (136) may be optionally supported through a GPS or other similar timing reference (142). When connected (138), the GPS or similar timing reference unit also connects (140) to the router for OA&M communication. The router (112) is connected either locally (154), or through the distribution network (120) to an element manager. The element manager provides a controlling user interface for OA&M. During network construction and commissioning, the element manager is used to set configuration parameters of each network element. For example, the protocol converter (104a, b) is configured to work with the type of base station port (100a, b) to which it is connected. The formatter (104a, b) is configured to combine receive data from various radio heads (132a, b, c, d). The router (112) is configured to direct packets from one base station port to may radio heads (132a, b, c, d) and to route packets from many radio heads (132a, b, c, d) to one base station port formatter (104a, b). All of these configuration commands are sent through the router (112) from an element manager.

The router (112) connects the base station concentrator (160) to the remote site distributor (162). This can be done by any direct bidirectional data link (114b) or by conversion to a standard data link. This conversion takes place in a transport module (116). Transport modules (116) support standard data links such as OC192, 10 gigabit Ethernet, and others well known to those skilled in the art.

The remote site distributor (160) begins with a connection between the base station distributor router (112) and the remote site distributor router (128). This connection can be achieved by any direct bidirectional data link (114b) or by conversion to a standard data link used by the distribution network (120). This conversion takes place in a transport module (124). Standard data links well known to those skilled in the art include OC192, 10 Giga bit Ethernet, etcetera. The remote site distributor (162) routes signal and OA&M packets to various radio heads (132a, b, c, d). Radio heads (132a, b, c, d) can be located within the remote site distributor (162) or external to it. In either case the router (128) distributes packets two and from radio heads (132a, b, c, d) and to other elements within the network. This distribution is based on radio head (132a, b, c, d) configuration information and packet addressing. Like the base station concentrator router (112), the remote site distributor router (128) connects to an element manager either by local connection (156), or through the distribution network interface (122). In the latter case for example, the remote site distributor router (128) may connect to an element manager via the distribution network (120), the base station concentrator router (112), and direct connection to the base station concentrator (154). In any case, OA&M configuration information is set in each network element via an element manager.

The remote site distributor (162) also includes a reference generator (144). This reference generator (144) must be synchronized with the reference generator (136) in the base station concentrator (160). Several synchronization options exist. For example, an optional global positioning system (GPS) receiver (152) can be included in both the base station concentrator (160) and each remote site distributor (162). All system references can then be synchronized to GPS time. In another example, synchronization can be achieved over the distribution network by following standard IEEE 1588 “Standard for a Precision Clock Synchronization Protocol for Networked Measurement and Control Systems,” the disclosure of which is incorporated herein by reference in its entirety. Following this synchronization method, the base station concentrator (162) would include the master reference (136) and each remote site distributor (162) would include a slave reference (144). The master reference (136) would then exchange two-way timing packets over the system network with the slave references (144) thereby producing synchronization. By providing base station concentrator (160) and remote site distributor (162) synchronization in such or similar ways, standard IP networks can be leased form commercial vendors. This provides a benefit over systems that recover system timing from a distribution network. The timing accuracy of existing commercial vendor IP distribution networks is generally insufficient for network synchronization. This requires such systems to build custom data networks where accurate timing can be established. These custom networks greatly increase system deployment costs.

The remote site distributor router (128) connects to one or more radio head units (132a, b, c, d) for signal and OA&M packet distribution. Radio heads can be connected either internal or external to the remote site distributor (162). A remote site distributor (162) with internal radio heads (132a, b) for example, may be placed at the top of a transmission tower. A remote site distributor (162) with external radio heads (132c, d) for example may be placed at the bottom of a transmission tower and the external radio heads (132c, d) may be attached at the tower top. A remote site distributor (162) with one internal (132a) and two external (132c, d) radio heads, may be used for a three-sector roof top deployment. In this example the distributor (162) and internal radio head (132a) would provide one sector and the other two external radio heads (132c, d) would provide the two other sectors. The three pieces of equipment could then be deployed on different corners of the building. Each of these examples, and there are may more, are generally based on end user preferences.

The connection from remote site distributor router (162) to each radio head (132a, b, c, d) may take many forms. The connection may include a packet data path and separate reference distribution path (see FIG. 3, 130a, b). The connection may only include the data path and the radio head (132c, d) recovers the system reference from the data bus. For external radio head deployments (132c, d), the data only connection would be preferred, and the link could be over a dedicated fiber optic transducer. This fiber optic transducer is not shown but such systems are well known to those skilled in the art.

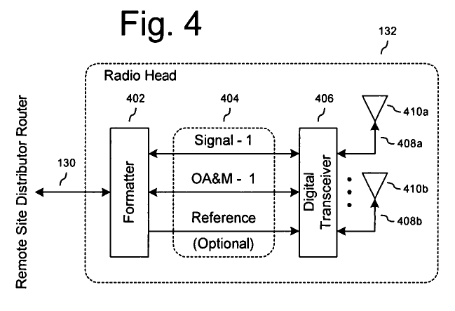

FIG. 4 shows a block diagram of one embodiment of a radio head (132). This embodiment is comprised of a data packet formatter (402), a digital transceiver (406), and one or more antennas (140a, b) used for MIMO or diversity purposes. The formatter (402) receives addressed data packets and produces a bi-direction data link carrying transmit and receive streams, isolates two-way OA&M communication, and can produce an optional frequency reference. The digital transceiver (406) uses the aforementioned information from the formatter (402) to produce the RF communication link to the wireless subscribers. This RF communication link may include transmission and reception from several antennas (410a, b). Common radio heads transmit and receive on one antenna (410a) and receive only on a second antenna (410b) producing receive diversity. Other radio heads transmit and receive on both antennas (410a, b) producing both transmit and receive diversity. Still other systems transmit and receive on several antennas (410a,b) thereby improving air interface link performance using MIMO methods.

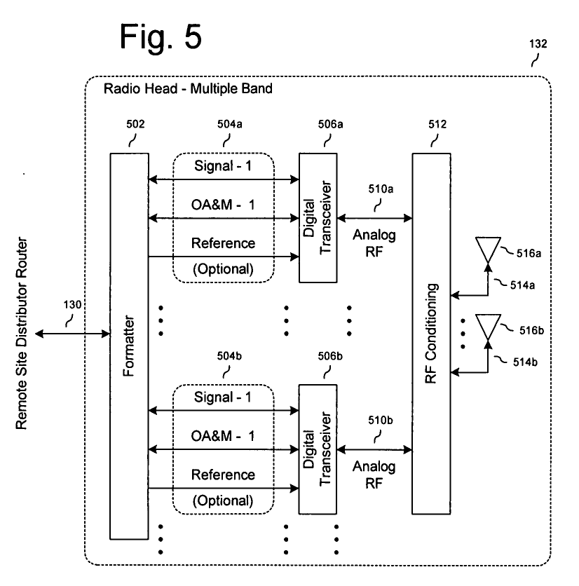

FIG. 5 shows a block diagram of another embodiment of a radio head (132). This embodiment is comprised of a data packet formatter (502) which supports several digital transceivers (506a, b). The digital transceiver outputs are combined using RF conditioning circuits (512) and connected to one or more antennas (516a, b) used for MIMO or diversity purposes. This radio head embodiment is similar to the one show in FIG. 4 with the formatter supporting several digital transceivers (506a, b) and the transmit and receive output paths of these transceivers (506a, b) sharing the same set of antennas (516a, b) through the use of RF conditioning networks (512). These RF conditioning networks (512) are constructed from passive filters, hybrid combiners and signal couplers. Such RF conditioning networks (512) are well known to those skilled in the art. The purpose of this embodiment is to increase the bandwidth of operation of a remote radio head (132). This could mean using more spectrum within one wireless band of operation such as the PCS band, or could mean occupying spectrum in several different wireless bands such as GSM, DCS, and the UMTS bands.

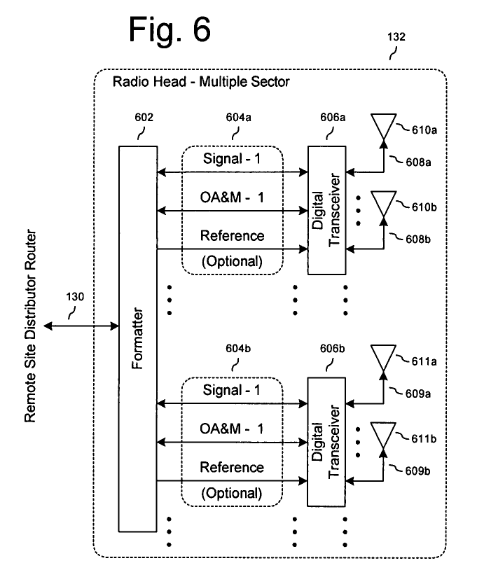

FIG. 6 shows a block diagram of another embodiment of a radio head (132). This embodiment is comprised of a data packet formatter (602) which supports several digital transceivers (606a, b), with the transceiver outputs each connected to one or more antennas (610a, b and 611a, b) used for MIMO or diversity purposes in separate sectors. As in the embodiment shown in FIG. 5, one formatter (602) connects to several different digital transceivers (606a, b). In this case, each transceiver (606a, b) is operated as in FIG. 4 with transmission and reception in different sectors.

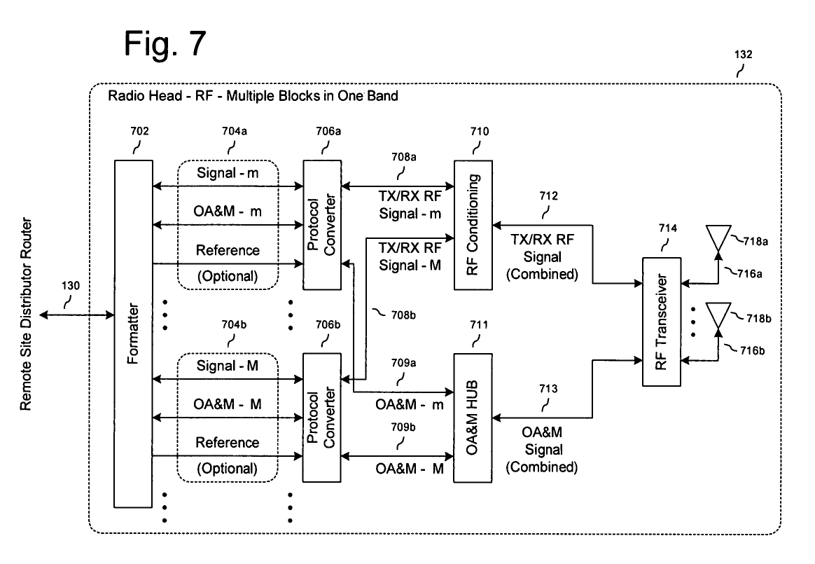

FIG. 7 shows a block diagram of one embodiment of a radio head (132). This embodiment is comprised of a data packet formatter (702) which supports several protocol converters (706a, b) with each protocol converter (706a, b) providing separate RF (708a, b) and OA&M (709a, b) paths. The RF (708a, b) paths are combined through RF signal conditioning (710), filter networks, hybrid combiners, etc.), and the OA&M paths are concentrated in a data hub (711). The RF combined and OA&M concentrated paths are connected to a single RF transceiver (714) supporting one or more antennas (716a, b) used for MIMO or diversity purposes. This embodiment is similar to that shown in FIG. 5 where a large span of frequency spectrum is occupied in a band such as the PCS band. In this case however the individual formatter outputs are converted to low power RF and OA&M communication in protocol converters (706a, b). The low power TX/RX signals (708a, b) are combined with RF conditioning circuits (710) as was described for FIG. 5 and OA&M messages are combined in a communication link hub (711). The combined RF TX/RX signals and OA&M communication are then connected to a RF transceiver (714). This RF transceiver is also connected to one or more antennas (718a, b) for diversity or MIMO link performance improvement purposes.

Each radio head embodiment shown (132a, b, c, d) includes a formatter block (402, 502, 602, 702) each of these formatter block includes the capacity to time delay both the transmit and receive information streams present on connections (404, 504, 604, 704) to either the digital transceivers (406, 506, 606) or the protocol converters (706a, b). This delay allows for proper timing of RF transmission and reception from individual radio heads (132a, b, c, d). Such timing is important when building simulcast distributed T/R locations. The time delay provided to each formatter (402, 502, 602, 702) link (404, 504, 604, 704) may be set by OA&M command from a network connected element manager.

The radio head embodiments shown (132a, b, c, d) in FIG. 4 through FIG. 7 should not be considered the limit of all radio head embodiments. Several hybrids of these embodiments could also be constructed and are within the scope of this invention.

Finally, remote site distributors (162) can also connect directly with other remote site distributors. This is shown by connection 158 in FIG. 1, FIG. 2, and FIG. 3. In this case the remote site distributor router (128) acts just as the router (112) in the base station concentrator (160). In fact, connection 158 could also use a transport modules and a distribution network to connect to other remote site distributors as is done between the base station router (160) and the remote site distributor (162) using elements identical to 116, 120, and 124. Since these routers are common IP routers, such connections are natural for network growth.

It will be appreciated by those skilled in the art that a variety of modifications to the preferred embodiments described herein are possible while remaining within the scope of the present invention.

What is claimed is:

1. A method of communicating signals to one or more wireless transmit locations, comprising the steps of:
receiving a plurality of signals having different protocols, from a plurality of base stations;
converting the plurality of signals into common digital network protocol signals; and
transmitting the common protocol signals over a transmission network to one or more wireless transmit locations.

2. The method of claim 1 wherein receiving a plurality of signals comprises receiving a plurality of signals having different protocols with independent frequency references and synchronizations.

3. The method of claim 2 wherein converting the plurality of signals comprises converting the plurality of signals from corresponding base station references into common network reference signals and synchronizations.

4. The method of claim 1 wherein receiving a plurality of differing protocol signals comprises receiving digital protocol signals and analog protocol signals.

5. The method of claim 4 wherein converting a communication signal from each base station reference into a common network reference signal further comprises digitally re-sampling the digital signal using the network reference.

6. The method of claim 4 wherein the analog protocol signals include baseband signals and wherein converting the plurality of signals further comprises digitally sampling the baseband signals.

7. The method of claim 4 wherein the analog protocol signals include RF or IF signals.

8. The method of claim 1 further comprising emulating said differing protocol signals in bidirectional communication with said plurality of base stations.

9. The method of claim 1 further comprising transmitting the common protocol signals from the transmit locations over one or more antennas.

10. The method of claim 1 wherein the one or more transmit locations include radio heads.

11. The method of claim 10 further comprising transmitting the common protocol signals from the radio heads over wireless channels.

12. The method of claim 1 wherein transmitting the common protocol signals further comprises transmitting the common protocol signals over a transmission network comprising an existing shared fiber network, to one or more wireless transmit locations.

13. The method of claim 1 further comprising the steps of:
transmitting digital signals using a common protocol, from one or more receive locations over the transmission network;
receiving the digital signals and converting the received digital signals into a plurality of signals having different protocols corresponding to a plurality of base stations implementing said different protocols; and
providing the plurality of differing protocol signals to said corresponding plurality of base stations.

14. The method of claim 13 wherein:
the common protocol digital signals comprise common network reference signals; and
converting the received digital signals further comprises converting the received common network reference signals into a plurality of differing base station reference signals.

15. The method of claim 14 wherein converting the received digital signals further comprises converting the received signals into a plurality of signals having different protocols with independent frequency references and synchronizations.

16. The method of claim 14 wherein converting a received common protocol signal further comprises re-sampling the received common protocol signal using a base station reference.

17. The method of claim 16 wherein converting the received digital signals further comprises converting the received digital signals into a plurality of differing protocol signals including digital protocol signals and analog protocol signals.

18. The method of claim 17 wherein the analog protocol signals include RF, IF or baseband signals.

19. The method of claim 13 wherein the one or more receive locations include radio heads.

20. The method of claim 13 wherein the transmission network comprises an existing shared fiber network.

21. A method of communicating signals to one or more wireless transmit locations, comprising the steps of:
receiving a plurality of signals having different protocols, from a plurality of base stations;
converting the plurality of signals into common network protocol digital streams;
formatting the digital streams into data packets for routing throughout a transmission network; and
transmitting the data packets over a packet transmission network to one or more wireless transmit locations.

22. The method of claim 21 wherein:
formatting the digital streams further includes formatting digital streams into internet protocol (IP) data packets; and
transmitting the data packets further includes transmitting the packets over a packet transmission network using the IP network transmission protocol.

23. The method of claim 22 wherein formatting the digital streams into packets further comprises including routing information in each packet to enable routing each packet through the packet transmission network to a selected transmit location.

24. The method of claim 21 wherein:
receiving a plurality of signals comprises receiving a plurality of signals having independent frequency references and synchronizations; and
converting the plurality of signals comprises converting the plurality of signals from corresponding base station references into common network reference digital streams and synchronizations.

25. The method of claim 21 wherein receiving a plurality of signals comprises receiving digital protocol and analog protocol signals.

26. The method of claim 21 further comprising converting the data in the packets into analog RF signals at the one or more transmit locations and transmitting the RF signals over one or more antennas.

27. The method of claim 26 wherein transmitting the packets comprises transmitting the data in the packets over a transmission network to a distributed antenna system, and retransmitting the data in the packets from the antenna system over one or more antennas.

28. The method of claim 32 wherein transmitting the packets comprises transmitting the packets over a transmission network to a distributed antenna system including multiple radio heads, and retransmitting the data in the packets from the radio heads over multiple antennas.

29. The method of claim 28 wherein transmitting the packets comprises simulcasting the packets containing data from a base station to several selected radio heads in the distributed antenna system, by creating several copies of each packet containing data from a base station, and transmitting the original and copy packets to several selected radio heads in the distributed antenna system.

30. A method of communicating signals to one or more wireless transmit locations, comprising the steps of:
receiving a plurality of signals having different protocols, from a plurality of base stations, wherein each base station operates using a particular protocol and frequency band;
converting the plurality of signals into common network protocol digital streams, including the steps of: (i) receiving a communication signal from a base station which uses a digital protocol, converting the base station data signal to a common baseband channel protocol digital stream, each common baseband channel spanning a fixed bandwidth including one or more frequency division carriers; (ii) receiving a communication signal from a base station which uses an analog protocol, converting the base station analog signal to a common baseband channel protocol digital stream, by performing analog to digital conversion on the analog signal using a network reference as a sampling clock; formatting the digital streams into data packets for routing throughout a transmission network; and
transmitting the packets over a packet transmission network to one or more transmit locations.

31. A distributed antenna system for digital transmission of signals to one or more remotely located transmit locations, comprising:
a concentrator that is configured to receive a plurality of signals having different protocols, from a plurality of base stations, and which converts the plurality of signals into common digital network protocol signals;
one or more wireless transmit locations each having one more antennas; and
a communication module that is configured to transmit the common protocol signals over a transmission network to said one or more wireless transmit locations.

32. The system of claim 31 wherein the plurality of signals have different protocols with independent frequency references and synchronizations.

33. The system of claim 32 wherein the concentrator includes a converter that is configured to convert the plurality of differing protocol signals from corresponding base station references into common network reference signals and synchronizations.

34. The system of claim 31 wherein the differing protocol signals comprise digital protocol signals and analog protocol signals.

35. The system of claim 34 wherein the concentrator includes a converter that is configured to convert a communication signal from each base station reference into a common network reference signal by digitally re-sampling the digital signal using the network reference.

36. The system of claim 34 wherein the analog protocol signals include baseband signals and wherein the converter is further configured to convert the plurality of signals by digitally sampling the baseband signals.

37. The system of claim 34 wherein the analog protocol signals include RF or IF signals.

38. The system of claim 31 wherein the concentrator is further configured to emulate said differing protocol signals in bidirectional communication with said plurality of base stations.

39. The system of claim 31 wherein the communication module is further configured to transmit the common protocol signals over a transmission network including an existing shared fiber network, to one or more of the remotely located transmit locations.

40. The system of claim 33 wherein:
the converter is further configured to convert the plurality of signals into common network protocol digital streams;
the concentrator further includes a formatter that is configured to format the digital streams into data packets for routing throughout a transmission network; and
the communication module is further configured to transmit the data packets over a packet transmission network to one or more of the remotely located transmit locations.

41. The system of claim 40 wherein:
the formatter is further configured to format the digital streams into internet protocol (IP) data packets; and
the communication module is further configured to transmit the data packets over a packet transmission network using the IP network transmission protocol.

42. The system of claim 41 wherein the formatter is further configured to include routing information in each packet to enable routing each packet through the packet transmission network to a selected transmit location.

43. The system of claim 33 wherein the concentrator is further configured to receive digital signals using a common protocol, from one or more wireless receive locations over the transmission network, and to convert the received digital signals into a plurality of signals having different protocols corresponding to the plurality of base stations implementing said different protocols.

44. The system of claim 43 wherein:
the common protocol digital signals comprise common network reference signals; and
the converter is further configured to convert the received common network reference signals into a plurality of differing base station reference signals.

45. The system of claim 44 wherein the converter is further configured to convert the received signals into a plurality of signals having different protocols with independent frequency references and synchronizations.

46. The system of claim 45 wherein the converter is further configured to convert the received common protocol signals by re-sampling the received common protocol signal using a base station reference.

47. The system of claim 40 wherein:
the communication module is further configured to receive data packets from the transmission network;
the formatter is further configured to transform the data in the packets into common network protocol digital streams; and
the converter is further configured to convert the received common network protocol digital streams into a plurality of differing base station reference signals.

48. The system of claim 47 wherein:
the received common network protocol digital streams include common network reference signals; and
the converter is further configured to convert the received common network reference signals into a plurality of differing base station reference signals.

49. The system of claim 48 wherein the received data packets include internet protocol (IP) data packets routed to the concentrator by the transmission network.
